(19) United States
(12) Patent Application Publication
(10) Pub. No.: US 2003/0169996 A1
(43) Pub. Date: Sep. 11, 2003

(54) Variable optical attenuator

(75) Inventors: Jung Hyun Lee, Suwon-Shi (KR); Ho Nam Kwon, Koyang-shi (KR); Sung Sik Yun, Chollanam-Do (KR); Jong Hyun Lee, Kwangju-Shi (KR); Sung Cheon Jung, Seoul (KR); Yoon Shik Hong, Sungnam-Shi (KR)

Correspondence Address: DARBY & DARBY P.C., 805 Third Avenue, New York, NY, 10022, US

(73) Assignee: SAMSUNG ELECTRO-MECHANICS CO., LTD., Suwon-Shi (KR)

(21) Appl. No.: 10/198,809

(22) Filed: Jul. 18, 2002

(30) Foreign Application Priority Data
Mar. 5, 2002 (KR) 2002-11700

(51) Int. Cl. G02B 6/26

(52) U.S. Cl. 385/140; 385/15

(57) ABSTRACT

Disclosed is a variable optical attenuator comprising: a transmitting fiber for transmitting light; a receiving fiber for receiving light from the transmitting fiber; an attenuating module provided between the transmitting and receiving fibers for attenuating light and having a transmitting unit, an attenuating unit and a receiving unit; an actuator for driving the attenuating unit; and a substrate supporting the transmitting fiber, the receiving fiber, the attenuating module and the actuator. The attenuating unit is driven offset in a lateral or angular motion to attenuate light. The transmitting, attenuating and receiving units of the attenuating module are formed into one module to obtain simple relative alignment of optical axes.

### BACKGROUND OF THE INVENTION

1. Field of the Invention

The present invention relates to a variable optical attenuator operating by an MEMS actuator, in particular, which has an attenuator module constituted of one module thereby simplifying relative optical axis alignment between optical fibers.

In particular, it is an object of the invention to provide a variable optical attenuator in which the attenuator module is made of a waveguide so as to have excellent endurance and optical features such as high insertion loss, influence of polarization, wavelength independency and the like.

Further, it is another object of the invention to provide a manufacturing process of the attenuator module of the variable optical attenuator being driven by the MEMS actuator.

2. Description of the Related Art

In general, an optical attenuator for optical communication is an optical component for adjusting the magnitude of an optical signal. The optical signal may have transmission loss of optical fiber occurring according to transmission distance and discontinuous factors occurring according to the number of connecting portions of the optical fiber, optical division coupling and optical component coupling. This may cause the magnitude of the optical signal to be different according to channels. Due to the difference of values as above, the optical attenuator is used to make the gain according to the channels be identical before magnification, and obtain an optical signal having a predetermined level after amplification.

According to its use, the optical attenuator is classified into a fixed optical attenuator for attenuating the quantity of light at a fixed value and a variable optical attenuator capable of adjusting the range of attenuation.

If the environment of using the fixed optical attenuator is changed after installation of the same, additional cost is consumed to deal a new environment as a disadvantage. On the other hand, the variable optical attenuator can actively change the gain of attenuation according to the environment. This allows the variable optical attenuator to function as an essential element for an optical network system requiring massive capacity or high speed.

Further, a proposed structure or method can take an effect to the scale or size of a component. A variable optical attenuator fabricated according to a lately developed MEMS technology has excellent advantages in downsizing and integration over a conventional mechanical variable optical attenuator with regard to performance, price, scale and component size.

This variable optical attenuator is required to satisfy optical features for optical communication such as variation in value due to wavelength, influence due to polarization, insertion loss and temporal response of an optical signal.

The conventional variable optical attenuator is generally divided into a waveguide-type attenuator using a thermo-optic effect of a silicon- or polymer-based material, a mechanical connector-type large-sized attenuator and an MEMS attenuator using an MEMS actuator.

Each of the above attenuators will be described as follows.

The waveguide-type variable optical attenuator forms a planar waveguide made of silicon or polymer, and adjusts the optical absorptivity of the waveguide while varying the temperature distribution of the waveguide using electrodes so as to attenuate an optical signal. The waveguide-type attenuator is adequate to a small-sized article, but disadvantageously has large amount of Polarization-Dependent Loss (PDL) and wavelength dependency.

The mechanical connector-type attenuator adopts a method of directly transforming an optical fiber to generate transmission loss due to macro bending, and a method of varying the connection distance between transmitting and receiving optical fibers to generate insertion loss. The mechanical large-sized variable optical attenuator has a wide range of available wavelength due to no wavelength dependency, however, it disadvantageously produces a large-sized and high-priced article.

Therefore, a variable optical attenuator using an MEMS actuator is under development in order to overcome the above disadvantage. Examples of the lately developed MEMS variable optical attenuator include a shutter-type attenuator, a tilting micro mirror-type attenuator, a Mechanical Anti-Reflection Switch (MARS) attenuator and the like.

First, the MARS variable optical attenuator performs a function of adjusting the amount of attenuation by placing a membrane of an MARS based upon the Fabry-Perot principle at an arbitrary displacement rather than an ON or OFF position. This MARS attenuator has a disadvantage that the amount of attenuation is varied according to wavelength.

The shutter-type MEMS variable optical attenuator arranges a shutter between a pair of transmitting and receiving optical fibers, and adjusts the connection area between the two optical fibers according to the displacement of the shutter to control insertion loss. However, the shutter-type variable optical attenuator is required to minimize the influence of an optical signal reflected from the shutter as a problem.

Finally, the tilting micro mirror-type variable optical attenuator adopts a method, which connects transmitting optical fibers using reflection of a mirror and controls insertion loss with each displacement of the mirror. In the tilting micro mirror-type variable optical attenuator, the mirror is necessarily fabricated parallel to a substrate. This requires the optical fibers to be aligned perpendicular to the substrate, and it is pointed that such a packaging is difficult.

### SUMMARY OF THE INVENTION

Accordingly the present invention has been made to solve the above problems and it is an object of the invention to provide a variable optical attenuator with a novel structure easy in relative optical axis alignment of optical fibers and low in optical signal interference, insertion loss and wavelength/polarization dependency and to fabricate such a variable optical attenuator using MEMS technology.

### BRIEF DESCRIPTION OF THE DRAWINGS

FIG. 1 is a perspective view illustrating the structure of a variable optical attenuator of the invention;

FIG. 2 is a conceptual view illustrating waveguide sections of a variable optical attenuator according to an embodiment of the invention;

FIG. 3 is a conceptual view illustrating waveguide sections of a variable optical attenuator according to another embodiment of the invention; and

FIG. 4 sequentially shows a fabricating process of a variable optical attenuator of the invention.

### DETAILED DESCRIPTION OF THE PREFERRED EMBODIMENT

The present invention relates to a variable optical attenuator comprising: a transmitting fiber for transmitting light; a receiving fiber for receiving light from the transmitting fiber; an attenuating module provided between the transmitting and receiving fibers for attenuating light and having a transmitting unit, an attenuating unit and a receiving unit; an actuator for driving the attenuating unit; and a substrate supporting the transmitting fiber, the receiving fiber, the attenuating module and the actuator.

According to a preferred embodiment of the invention, the transmitting, attenuating and receiving units of the attenuating module are formed into one module to obtain simple relative alignment of optical axes.

Preferably, the attenuating module is made of a waveguide to reduce the alignment error among the transmitting, attenuating and receiving units thereby reducing optical transmission loss.

Preferably, the attenuating unit is driven offset in a lateral motion to attenuate light.

Alternatively, the attenuating unit is driven offset in an angular motion to attenuate light.

According to another embodiment of the invention rather than the above embodiment, it is provided a variable optical attenuator comprising: a transmitting fiber for transmitting light; a receiving fiber for receiving light from the transmitting fiber; an attenuating module provided between the transmitting and receiving fibers for attenuating light and having a transmitting unit, an attenuating unit for attenuating light and a receiving unit positioned offset to the transmitting unit; an actuator for driving the attenuating unit; and a substrate supporting the transmitting fiber, the receiving fiber, the attenuating module and the actuator.

Preferably, the transmitting, attenuating and receiving units of the attenuating module are formed into one module to achieve simple relative alignment of optical axes.

Preferably, each of the transmitting, attenuating and receiving units of the attenuating module is made of a waveguide to reduce the alignment error among the transmitting, attenuating and receiving units thereby reducing optical transmission loss.

In the variable optical attenuator of the invention, the attenuating unit is driven offset in a lateral motion or an angular motion to attenuate light.

The present invention also provides a process for fabricating the variable optical attenuator.

The process for fabricating the variable optical attenuator comprises the following steps of: depositing a sacrificing layer on a substrate; forming a silicon device layer on the sacrifice layer; forming a planar waveguide layer on the silicon device layer; patterning the planar waveguide layer through etching to divide the same into three portions; patterning the silicon device layer through etching to divide the same into three portions; removing the middle portions of the planar waveguide layer and the silicon device layer divided into the tree portions, respectively; and bonding optical fibers to both sides of the remaining portions of the planar waveguide layer and the silicon device layer divided into the tree portions.

Hereinafter it will be described about embodiments of the invention in reference to the accompanying drawings.

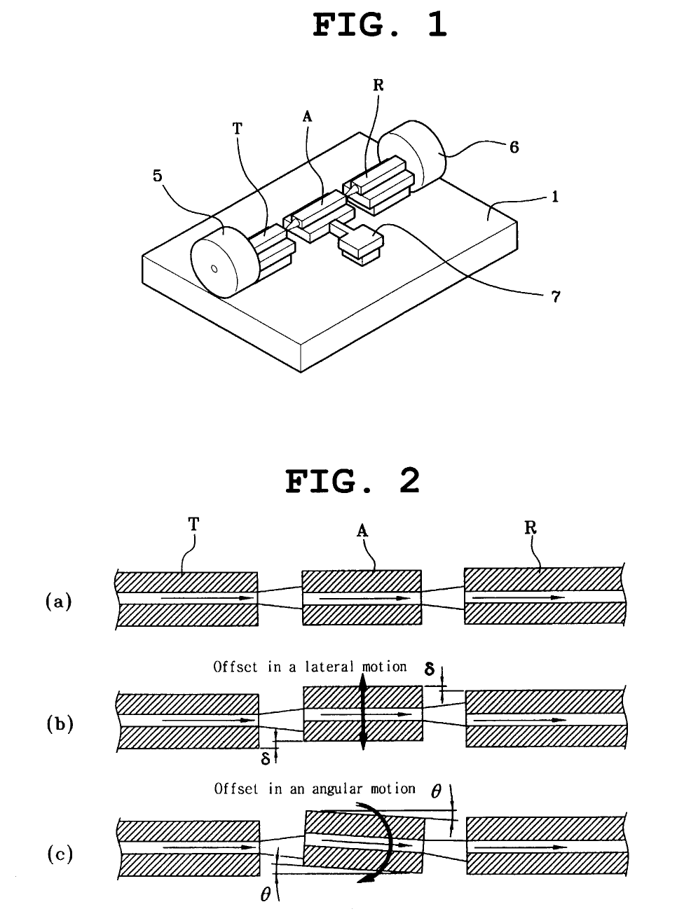

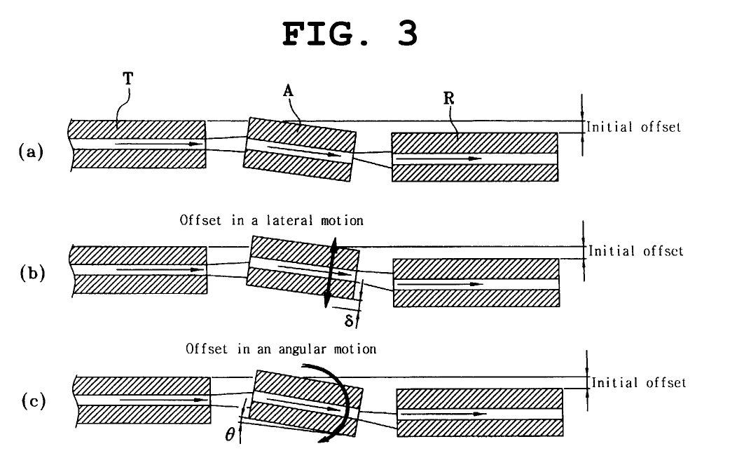

FIG. 1 is a perspective view illustrating the structure of a variable optical attenuator of the invention, and FIGS. 2 and 3 are conceptual views illustrating the structures of MEMS variable optical attenuators as set forth above. As shown in FIG. 1, the variable optical attenuator comprises an attenuating module provided between the transmitting fiber and the receiving fiber for attenuating light, in which the attenuating module is constituted of a transmitting unit T, an attenuating unit A operating in offset motions and a receiving unit R.

In the attenuating module, the transmitting unit T, the attenuating module A and the receiving module R may be constituted into one module so that relative alignment of optical axes can be realized easily.

Further, the attenuating module is made of a waveguide to reduce optical transmission loss thereby elevating transmission efficiency.

The attenuating module can be horizontally aligned to a planar substrate and uses a planar waveguide and the like. There are advantages that the attenuating module can adjust intervals of the planar waveguide to improve insertion loss, have a structure without thermal effect or reflection to reduce dependency according to polarization or wavelength, and be constituted into one module to enable downsizing and integration.

Generally in the optical attenuator, alignment of the waveguide influences the coupling efficiency of the transmitting and receiving units so that insertion loss which is an important performance factor can be determined.

A conventional MEMS optical attenuator requires micro-alignment in a packaging process such as alignment between transmitting and receiving optical fibers and alignment between the optical fibers and an MEMS actuator. In the optical attenuator of the invention, however, the attenuating module and an MEMS actuator are fabricated in the same exposure process so that alignment between the attenuating module and the actuator is simultaneously performed in a chip fabricating process. Further, the attenuating module is fabricated in a single chip process to allow more precise alignment between the optical fibers over manual alignment of optical fibers in the packaging process.

The attenuation principle is generally classified into two methods: The first method, as shown in FIG. 2, primarily aligns the transmitting unit T, the attenuating unit A and the receiving unit R in line, and drives an optical waveguide corresponding to the attenuating unit A to be offset in a lateral or angular motion in respect to alignment of the transmitting unit T and the receiving unit R so as to attenuate the quantity of light.

The second method, as shown in FIG. 3, primarily arranges the transmitting unit T and the receiving unit R in a mis-aligned position instead of aligning the same in line, and drives the attenuating unit A to be offset for δ or ⊖ in a lateral or angular motion so as to attenuate the quantity of light.

The second method has advantages over the first method that the influence of retroreflection can be minimized and the area of attenuating the quantity of light can be increased in the maximum offset for minimizing the quantity of light.

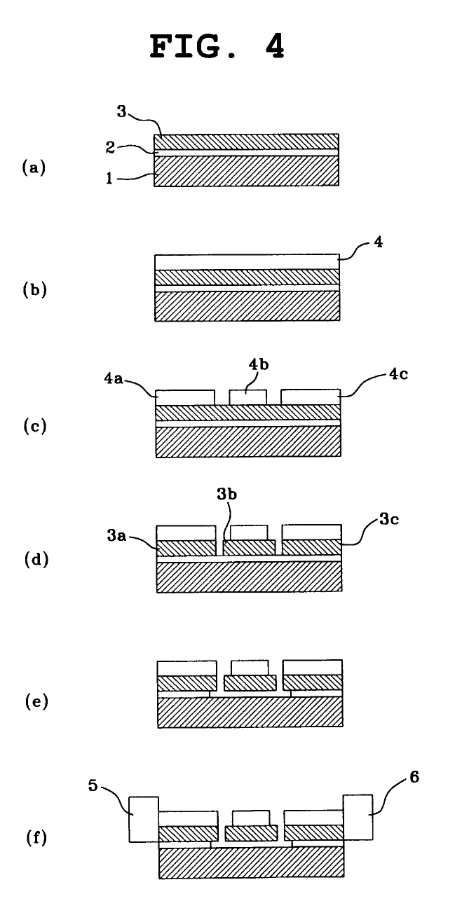

FIG. 4 sequentially shows a fabricating process of a variable optical attenuator of the invention.

In the process of the invention, as shown in FIG. 4, a sacrificing layer 2 is primarily deposited on a substrate 1. A silicon device layer 3 is formed on the deposited sacrifice layer 2, and a planar waveguide layer 4 is formed on the silicon device layer 3.

The planar waveguide layer 4 is patterned through etching to divide the same into three portions, in which intervals between the portions are 2 to 10 μm. Further, the silicon device layer 3 is patterned through etching to divide the same into three portion, in which intervals between the portions are 2 to 10 μm. At this time, a driving unit is fabricated.

The driving unit is completed through sacrificing layer etching of the middle portions 3b and 4b in the silicon device layer 3 and the planar waveguide layer 4 divided into the three portions.

Finally, optical fibers 5 and 6 are bonded to the portions 3a; 3c; 4a and 4c at both sides of the silicon device layer 3 and the planar waveguide layer 4 except for the middle portions 3b and 4b thereof so as to complete the variable optical attenuator having the transmitting unit T, the attenuating unit A and the receiving unit R shown in FIG. 1.

In this case, the attenuating unit of the waveguide is movable as detached from the substrate and thus capable of performing a lateral linear motion or an angular rotational motion in respect to alignment of the transmitting and receiving units, and the transmitting and receiving units made of the waveguide are fabricated as aligned with exposure precision in the chip process.

As set forth above, the MEMS variable optical attenuator of the invention are apparently excellent in loss feature, wavelength dependency, downsizing probability and the like over variable optical attenuators based upon other driving modes.

The MEMS variable optical attenuator of the invention carries out attenuation according to the amount of offset of the optical waveguide. Therefore, the variable optical attenuator of the invention reduces the influence from wavelength or polarization unlike a conventional variable optical attenuator which carries out optical attenuation through variation of refractive index due to thermo-optic properties or using a rotating mirror. Further, one exposure process fabricates the transmitting unit, the attenuating unit and the receiving unit while aligning the same to achieve an excellent alignment efficiency, thereby resulting in a structure capable of reducing insertion loss.

In FIG. 3, the attenuating unit is inclined due to the initial offset of the transmitting and receiving units so as to reduce the influence of retroreflection in the attenuating unit and increase the area of attenuating the quantity of light. In FIG. 2, the influence of retroreflection can be reduced by using a solution for fixing refractive index.

In FIGS. 2 and 3, the transmitting, receiving and attenuating units may be provided at the ends with angle cleavings, which have angles of a critical angle or more in general, and experimentally about 8 deg. in particular to reduce the influence of retroreflection.

Further, the waveguide can be arranged parallel to the substrate to achieve downsizing or simple packaging and adjacent to the same to exclude the necessity of a collimator, thereby resulting in an effect of avoiding sophistication in structure of the rotary mirror-type MEMS variable optical attenuator. Therefore, the inventive variable optical attenuator can be developed as an article lower-priced and downsized in respect to a mechanical variable optical attenuator.

The variable optical attenuator of the present invention which is driven by the MEMS actuator has excellent optical features such as insertion loss, influence of polarization, wavelength independency and the like and excellent durability to allow downsizing and mass-production more efficient over the conventional mechanical optical attenuator while utilizing the advantages of MEMS technology to develop a competitive article as an effect.

Although the preferred embodiments of the present invention have been disclosed for illustrative purposes, those skilled in the art will appreciate that various modifications, additions and substitutions can be made without departing from the scope and spirit of the invention as disclosed in the accompanying claims.

What is claimed is:

1. A variable optical attenuator comprising:
a transmitting fiber for transmitting light;
a receiving fiber for receiving light; and
an attenuating module between said transmitting and receiving fibers for attenuating light, wherein said attenuating module comprises a transmitting unit, an attenuating unit and a receiving unit.

2. The variable optical attenuator according to claim 1, wherein each of said transmitting, attenuating and receiving units of the attenuating module is made of a waveguide.

3. The variable optical attenuator according to claim 1, wherein said transmitting, attenuating and receiving units of the attenuating module are formed into one module to obtain simple relative alignment of optical axes.

4. The variable optical attenuator according to claim 1, wherein said attenuating module further comprises an MEMS actuator for driving said attenuating unit.

5. The variable optical attenuator according to claim 1, wherein said transmitting unit is connected to said transmitting fiber, said receiving unit is connected to said receiving fiber, and said attenuating unit is driven by an MEMS actuator between said transmitting and receiving units for attenuating light.

6. The variable optical attenuator according to claim 1, wherein said receiving unit is coaxial with said transmitting unit.

7. The variable optical attenuator according to claim 1, wherein said receiving unit is offset from said transmitting unit.

8. The variable optical attenuator according to claim 1, wherein said attenuating unit is driven offset in a lateral motion to attenuate light.

9. The variable optical attenuator according to claim 1, wherein said attenuating unit is driven offset in an angular motion to attenuate light.

10. A variable optical attenuator comprising:
a transmitting fiber for transmitting light;
a receiving fiber for receiving light from said transmitting fiber;
an attenuating module provided between said transmitting and receiving fibers for attenuating light and having a transmitting unit, an attenuating unit and a receiving unit;
an actuator for driving said attenuating unit; and
a substrate supporting said transmitting fiber, said receiving fiber, said attenuating module and said actuator.

11. The variable optical attenuator according to claim 10, wherein said transmitting, attenuating and receiving units of the attenuating module are formed into one module to achieve simple relative alignment of optical axes.

12. The variable optical attenuator according to claim 10, wherein each of said transmitting, attenuating and receiving units of the attenuating module is made of a waveguide.

13. The variable optical attenuator according to claim 10, wherein said receiving unit is coaxial with said transmitting unit.

14. The variable optical attenuator according to claim 10, wherein said receiving unit is offset from said transmitting unit.

15. The variable optical attenuator according to claim 10, wherein said attenuating unit is driven offset in a lateral motion to attenuate light.

16. The variable optical attenuator according to claim 10, wherein said attenuating unit is driven offset in an angular motion to attenuate light.

17. A method of fabricating a variable optical attenuator comprising the following steps of:
depositing a sacrificing layer on a substrate;
forming a silicon device layer on the sacrifice layer;
forming a planar waveguide layer on the silicon device layer;
patterning the planar waveguide layer through etching to divide the same into three portions;
patterning the silicon device layer through etching to divide the same into three portions;
removing the middle portions of the planar waveguide layer and the silicon device layer divided into the tree portions, respectively; and
bonding optical fibers to both sides of the remaining portions of the planar waveguide layer and the silicon device layer divided into the tree portions.
